(19) United States
(12) Patent Application Publication
(10) Pub. No.: US 2026/0188727 A1
(43) Pub. Date: Jul. 2, 2026

(54) LITHIUM-ION CONDUCTIVE GLASS CERAMIC PRECURSOR

(71) Applicant: OHARA INC, Sagamihara-shi, Kanagawa (JP)

(72) Inventor: Kazuhito Ogasa, Sagamihara-Shi (JP)

(73) Assignee: OHARA INC, Sagamihara-shi, Kanagawa (JP)

(21) Appl. No.: 19/129,125

(22) PCT Filed: Aug. 3, 2023
(86) PCT No.: PCT/JP2023/028404

§ 371 Date: May 12, 2025

(30) Foreign Application Priority Data
Nov. 14, 2022 (JP) 2022-181658

(51) Int. Cl. H01M 10/0562; C03C 4/18; C03C 10/00; H01M 10/052

(52) U.S. Cl. CPC H01M 10/0562; C03C 4/18; C03C 10/00; H01M 10/052; H01M 2300/0068

(57) ABSTRACT

The lithium-ion conductive glass ceramic precursor has a compositional ratio of P, Al, Ge, and Li satisfies a compositional ratio represented by a compositional formula of Li₁₊ₓAlₓGe_{2-x-z}M_{z}P₃O₁₂ (x=0.2 to 0.6, z=0 to 0.1, and M is one or more selected from the group consisting of Zr, Ti, Sn, and Si). When particles of the lithium-ion conductive glass ceramic precursor that have passed through a mesh with an aperture size of 106 μm are sintered and crystallized at a temperature of 700° C. or lower, an amount of moisture released at 550 to 700° C. is 60 ppm or less per the lithium-ion conductive glass ceramic precursor.

### TECHNICAL FIELD

The present invention relates to a lithium-ion conductive glass ceramic precursor, as well as an all-solid-state secondary battery including as a solid electrolyte a lithium-ion conductive glass ceramic formed by sintering the same.

### BACKGROUND ART

Chargeable and dischargeable lithium-ion secondary batteries with high energy density are widely used in applications such as power supplies for electric vehicles and power supplies for cell phone terminals.

Most lithium-ion secondary batteries currently on the market use liquid electrolyte (electrolytic solution) to ensure that they have a high energy density. A material prepared by dissolving lithium salt in a non-protic organic solvent such as carbonate ester or cyclic ester is usually used as the electrolytic solution.

However, in lithium-ion secondary batteries using liquid electrolyte (electrolytic solution), there is a risk of electrolyte leakage. In addition, organic solvents and other materials commonly used in electrolytic solution are volatile and flammable substances, and the problem is that the substances are undesirable from a safety standpoint.

Thus, it has been proposed to use a solid electrolyte as the electrolyte of a lithium-ion secondary battery instead of liquid electrolyte (electrolytic solution) such as an organic solvent. In addition, development of all-solid-state secondary batteries, in which solid electrolyte is used as the electrolyte and all other components such as the electrode layer are also composed of solid, is underway.

Typical properties required for solid electrolyte for all-solid-state secondary batteries include lithium ion conductivity and sintering properties. In addition, a high density after sintering is also required for good interface formation with the electrode layer and other materials (formation of an interface with low resistance).

Examples of solid electrolytes for all-solid-state secondary batteries include sulfide solid electrolytes as typified by LISICON type structure such as Li₄₋ₓGe₁₋ₓPₓS₄, and oxide solid electrolytes as typified by NASICON type structure such as Li₁₊ₓAlₓGe₂₋ₓP₃O₁₂ and Li₁₊ₓAlₓTi₂₋ₓP₃O₁₂, and perovskite type structure such as La_{2/3-x}Li₃ₓTiO₃. More specific examples of oxide solid electrolytes are given, such as those described in Patent Documents 1 to 3 and Non-Patent Document 1. In particular, it is known that Li₁₊ₓAlₓGe₂₋ₓP₃O₁₂ (LAGP) and Li₁₊ₓAlₓTi₂₋ₓP₃O₁₂ (LATP) with NASICON type structure can be crystallized from the vitreous state and thus can provide those having a high lithium ion conductivity at a relatively low sintering temperature.

### CITATION LIST

### Patent Documents

PATENT DOCUMENT 1: Japanese Patent Laid-Open No. 2007-258165
PATENT DOCUMENT 2: Japanese Patent Laid-Open No. 2013-112599
PATENT DOCUMENT 3: Japanese Patent Laid-Open No. 2021-174766

### Non-Patent Document

NON-PATENT DOCUMENT 1: Journal of Power Sources 192 (2009) 689-692

### SUMMARY OF THE INVENTION

### Problem to be Solved by the Invention

Here, there would be two major ways to fabricate oxide all-solid-state secondary batteries constituted with a positive electrode layer, a solid electrolyte layer, and a negative electrode layer. The first method is to use any of the positive electrode layer, solid electrolyte layer, or negative electrode layer as a substrate and sinter the remaining layers thereon, while the second method is to integrally sinter and mold all of the positive electrode layer, solid electrolyte layer, negative electrode layer, and if necessary, an interconnector layer (co-sintering). In particular, among all-solid-state secondary batteries using oxide solid electrolytes, those of the multilayer ceramic capacitor (MLCC) type are required to be fabricated by co-sintering. Then, in the case of integrally molding the electrode layer and the solid electrolyte layer, it is desirable to perform sintering at a sintering temperature as low as possible in order to suppress decomposition of the electrode active material and reduction in the discharge capacity (battery capacity) as much as possible; however, from the viewpoint of forming an oxide solid electrolyte layer with the predetermined lithium ion conductivity, density, and other properties, sintering is usually performed at a temperature of higher than 700° C.

The solid electrolyte shown in Non-Patent Document 1 is known to react with the electrode active material (positive electrode active material or negative electrode active material) and is known to be difficult to undergo co-sintering at a temperature of higher than 700° C. Meanwhile, Patent Document 1 discloses a battery sintered at 800° C. using a solid electrolyte Li_{1.5}Al_{0.5}Ge_{1.5}P₃O₁₂ with a NASICON structure, but this has a high resistance of 10 kΩ and a low lithium ion conductivity of 3×10⁻⁷ S/cm, as calculated from the area and thickness.

Furthermore, some focus on changing the composition of LAGP, as shown in Patent Document 2, but this does not disclose the density after sintering necessary for good interface formation. And although LAGP glass materials (oxide glass materials including Li, Al, Ge, and P as essential components, in which their compositional ratio satisfies Li₁₊ₓAlₓGe₂₋ₓP₃O₁₂ or an equivalent compositional ratio) can be crystallized (glass ceramization) at a lower sintering temperature compared to LATP glass materials (oxide glass materials including Li, Al, Ti, and P as essential components, in which their compositional ratio satisfies Li₁₊ₓAlₓTi₂₋ₓP₃O₁₂ or an equivalent compositional ratio), there is a problem that it is difficult to obtain a solid electrolyte with a higher density, and it has not been possible to acquire a solid electrolyte with a high density that can substantially constitute a good electrode layer interface and the like in all-solid-state secondary batteries.

In addition, Patent Document 3 discloses a method for producing a solid lithium-ion conductor material, in which contact with water or water vapor is carried out in a stage where the starting materials are melted in a high temperature process and the resulting intermediate products are cooled or quenched, or in a stage where a low temperature process is performed in the subdivision stage to produce powder, followed by drying (for example, freeze drying followed by baking in a nitrogen atmosphere and then vacuum drying), and ceramization is carried out at a high temperature (for example, 950° C.). However, adding water or water vapor to LAGP glass materials causes compositional shifts that make production difficult, and also make low temperature sintering difficult. In addition, some components are dissolved in moisture, making it difficult for materials including these dissolved and hydrated components to have a high density.

Accordingly, an object of the present invention is to provide a lithium-ion conductive glass ceramic precursor that is a LAGP glass material from which a lithium-ion conductive glass ceramic with a high density can be formed by sintering at 700° C. or lower.

### Means for Solving the Problem

The present inventors have conducted intensive studies to solve the above problem, and have found that the reason why it is difficult to achieve a high density of glass ceramics obtained by sintering LAGP glass materials at a low temperature is that moisture dissolved in the glass material is gasified during sintering thereof, and unlike the case where moisture adsorbed (chemically adsorbed or physically adsorbed) on the surface is gasified, it is difficult to escape instantly. Then, they have found that, by a lithium-ion conductive glass ceramic precursor that is a glass material, in which the compositional ratio of P, Al, Ge, and Li satisfies a compositional ratio represented by the compositional formula of Li₁₊ₓAlₓGe_{2-x-z}M_{z}P₃O₁₂ (x=0.2 to 0.6, z=0 to 0.1, and M is one or more selected from the group consisting of Zr, Ti, Sn, and Si) or a compositional ratio represented by the compositional formula of Li₁₊ₓAlₓGe_{2-x-z}M_{z}P₃O₁₂+aLi₂O+bP₂O₅ (x=0.2 to 0.6, z=0 to 0.1, a=0.01 to 0.3, b=0 to 0.3, and M is one or more selected from the group consisting of Zr, Ti, Sn, and Si), and when particles that have passed through a mesh with an aperture size of 106 μm are sintered and crystallized at a temperature of 700° C. or lower, the amount of moisture released at 550 to 700° C. is 60 ppm or less, a lithium-ion conductive glass ceramic with a higher density can be formed by low temperature sintering at 700° C. or lower.

That is, the present invention includes the following <1> to <5>.
<1> A lithium-ion conductive glass ceramic precursor that is a glass material from which a lithium-ion conductive glass ceramic can be formed by sintering, wherein a compositional ratio of P, Al, Ge, and Li satisfies a compositional ratio represented by a compositional formula of Li₁₊ₓAlₓGe_{2-x-z}M_{z}P₃O₁₂ (x=0.2 to 0.6, z=0 to 0.1, and M is one or more selected from the group consisting of Zr, Ti, Sn, and Si), and when particles of the lithium-ion conductive glass ceramic precursor that have passed through a mesh with an aperture size of 106 μm are sintered and crystallized at a temperature of 700° C. or lower, an amount of moisture released at 550 to 700° C. is 60 ppm or less per the lithium-ion conductive glass ceramic precursor.
<2> The lithium-ion conductive glass ceramic precursor according to <1>, containing, in mole percent on an oxide basis, 0.05 to 2.4% of a ZrO₂ component.
<3> A lithium-ion conductive glass ceramic precursor that is a glass material from which a lithium-ion conductive glass ceramic can be formed by sintering, wherein a compositional ratio of P, Al, Ge, and Li satisfies a compositional ratio represented by a compositional formula of Li₁₊ₓAlₓGe_{2-x-z}M_{z}P₃O₁₂+aLi₂O+bP₂O₅ (x=0.2 to 0.6, z=0 to 0.1, a=0.01 to 0.3, b=0 to 0.3, and M is one or more selected from the group consisting of Zr, Ti, Sn, and Si), and when particles of the lithium-ion conductive glass ceramic precursor that have passed through a mesh with an aperture size of 106 μm are sintered and crystallized at a temperature of 700° C. or lower, an amount of moisture released at 550 to 700° C. is 60 ppm or less per the lithium-ion conductive glass ceramic precursor.
<4> The lithium-ion conductive glass ceramic precursor according to <3>, containing, in mole percent on an oxide basis, 0.05 to 2.4% of a ZrO₂ component.
<5> An all-solid-state secondary battery including as a solid electrolyte a lithium-ion conductive glass ceramic formed by sintering the lithium-ion conductive glass ceramic precursor according to any one of <1> to <4>.

### Effect of the Invention

The present invention can provide a lithium-ion conductive glass ceramic precursor that is a LAGP glass material from which a lithium-ion conductive glass ceramic with a high density can be formed by sintering at 700° C. or lower.

### BRIEF DESCRIPTION OF THE DRAWINGS

FIG. 1 is a graph showing the humidity measurement results for the lithium-ion conductive glass ceramic precursors of Example 2, Example 3, and Comparative Example 4 when sintered and crystallized at a low temperature.

FIG. 2 is a graph showing the humidity measurement results for the lithium-ion conductive glass ceramic precursors of Comparative Example 4 with different particle sizes when sintered and crystallized at a low temperature.

FIG. 3 is a graph showing the humidity measurement results for a lithium-ion conductive glass ceramic precursor (25 μm mesh-passed product) of Comparative Example 4 when sintered and crystallized at a low temperature.

FIG. 4 is a secondary electron image (an image substituting drawing) of a broken-out section for the sintered pellets of Comparative Example 1 (left) and Example 3 (right).

### DESCRIPTION OF EMBODIMENTS

The present invention will be described.

The present invention is a lithium-ion conductive glass ceramic precursor that is a glass material from which a lithium-ion conductive glass ceramic can be formed by sintering, in which the compositional ratio of P, Al, Ge, and Li satisfies a compositional ratio represented by the compositional formula of Li₁₊ₓAlₓGe_{2-x-z}M_{z}P₃O₁₂ (x=0.2 to 0.6, z=0 to 0.1, and M is one or more selected from the group consisting of Zr, Ti, Sn, and Si) or the compositional ratio of P, Al, Ge, and Li satisfies a compositional ratio represented by the compositional formula of Li₁₊ₓAlₓGe_{2-x-z}M_{z}P₃O₁₂+aLi₂O+bP₂O₅ (x=0.2 to 0.6, z=0 to 0.1, a=0.01 to 0.3, b=0 to 0.3, and M is one or more selected from the group consisting of Zr, Ti, Sn, and Si), and when particles of the lithium-ion conductive glass ceramic precursor that have passed through a mesh with an aperture size of 106 μm are sintered and crystallized at a temperature of 700° C. or lower, the amount of moisture released at 550 to 700° C. is 60 ppm or less per the lithium-ion conductive glass ceramic precursor.

In the following, they may also be referred to as “the lithium-ion conductive glass ceramic precursors of the present invention.” Also, of these, an embodiment that satisfies the former compositional ratio may be referred to as “the first embodiment” and an embodiment that satisfies the latter compositional ratio may be referred to as “the second embodiment.”

First, the components and composition constituting the lithium-ion conductive glass ceramic precursors of the present invention will be described in detail.

The lithium-ion conductive glass ceramic precursors of the present invention include a P component, an Al component, a Ge component, and a Li component as essential components, and their compositional ratio in the first embodiment satisfies a compositional ratio represented by the compositional formula of Li₁₊ₓAlₓGe_{2-x-z}M_{z}P₃O₁₂ (x=0.2 to 0.6, z=0 to 0.1, and M is one or more selected from the group consisting of Zr, Ti, Sn, and Si) and their compositional ratio in the second embodiment satisfies a compositional ratio represented by the compositional formula of Li₁₊ₓAlₓGe_{2-x-z}M_{z}P₃O₁₂+aLi₂O+bP₂O₅ (x=0.2 to 0.6, z=0 to 0.1, a=0.01 to 0.3, b=0 to 0.3, and M is one or more selected from the group consisting of Zr, Ti, Sn, and Si).

The contents of the components contained in the lithium-ion conductive glass ceramic precursors of the present invention are all in mole percent on an oxide basis unless otherwise specified (hereinafter, simple description of mol % means mol % on an oxide basis, unless otherwise specified). The contents “in mole percent on an oxide basis” mean the contents of the respective components contained in the lithium-ion conductive glass ceramic precursors of the present invention, assuming that all the oxides, complex salts, metal fluorides, and the like used as raw materials of the lithium-ion conductive glass ceramic precursors of the present invention are decomposed and converted into oxides when melted, taking the total number of moles of the resulting oxides as 100 mol %.

(1) Essential Components and their Composition in First Embodiment

The P₂O₅ component is an essential component necessary for glass formation of the LAGP glass material of the first embodiment and for a lithium-ion conductive glass ceramic formed by sintering the first embodiment to include a crystal phase with a rhombohedral NASICON structure and to have an excellent lithium ion conductivity. Thus, the lower limit of the content of the P₂O₅ component is preferably 34.0 mol %, more preferably 35.0 mol %, further preferably 36.0 mol %, and still more preferably 37.0 mol %. Also, since it can be made easier to obtain a crystal phase with a rhombohedral NASICON structure by sintering, the upper limit of the content of the P₂O₅ component is preferably 45.0 mol %, more preferably 44.0 mol %, further preferably 43.0 mol %, still more preferably 42.0 mol %, still further preferably 41.0 mol %, yet more preferably 40.0 mol %, yet further preferably 39.0 mol %, and even more preferably 38.0 mol %. For example, the first embodiment is more suitable if it has a configuration containing 37.0 to 42.0 mol % of the P₂O₅ component.

The Al₂O₃ component is an essential component necessary for a lithium-ion conductive glass ceramic formed by sintering the first embodiment to include a crystal phase with a rhombohedral NASICON structure and also to have an excellent lithium ion conductivity. Thus, the lower limit of the content of the Al₂O₃ component is preferably 0.5 mol %, more preferably 1.0 mol %, further preferably 2.0 mol %, still more preferably 3.0 mol %, still further preferably 4.0 mol %, and yet more preferably 4.5 mol %. Also, since it can be made easier to obtain a crystal phase with a rhombohedral NASICON structure by sintering, the upper limit of the content of the Al₂O₃ component is preferably 10.0 mol %, more preferably 9.0 mol %, further preferably 8.0 mol %, still more preferably 7.0 mol %, still further preferably 6.0 mol %, and yet more preferably 5.5 mol %. For example, the first embodiment is more suitable if it has a configuration containing 2.0 to 7.0 mol % of the Al₂O₃ component.

The GeO₂ component is also an essential component necessary for a lithium-ion conductive glass ceramic formed by sintering the first embodiment to include a crystal phase with a rhombohedral NASICON structure and also to have an excellent lithium ion conductivity. Thus, the lower limit of the content of the GeO₂ component is preferably 29.0 mol %, more preferably 30.0 mol %, further preferably 31.0 mol %, still more preferably 32.0 mol %, still further preferably 33.0 mol %, yet more preferably 34.0 mol %, yet further preferably 35.0 mol %, even more preferably 36.0 mol %, even further preferably 37.0 mol %, even still more preferably 38.0 mol %, and even still further preferably 39.0 mol %. Also, since it can be made easier to obtain a crystal phase with a rhombohedral NASICON structure by sintering, the upper limit of the content of the GeO₂ component is preferably 49.0 mol %, more preferably 48.0 mol %, further preferably 47.0 mol %, still more preferably 46.0 mols, still further preferably 45.0 mols, yet more preferably 44.0 mol %, yet further preferably 43.0 mol %, even more preferably 42.0 mol %, and even further preferably 41.0 mol %. For example, the first embodiment is more suitable if it has a configuration containing 32.0 to 46.0 mol % of the GeO₂ component.

The Li₂O component is an essential component necessary for imparting lithium ion conductivity to a lithium-ion conductive glass ceramic formed by sintering the first embodiment. Thus, the lower limit of the content of the Li₂O component is preferably 12.0 mol %, more preferably 13.0 mol %, further preferably 14.0 mol %, still more preferably 15.0 mol %, still further preferably 16.0 mols, and yet more preferably 17.0 mol %. Meanwhile, since it can be made easier to obtain a crystal phase with a rhombohedral NASICON structure by sintering, the upper limit of the content of the Li₂O component is preferably 22.0 mol %, more preferably 21.0 mol %, further preferably 20.0 mol %, still more preferably 19.0 mol %, and still further preferably 18.0 mol %. For example, the first embodiment is more suitable if it has a configuration containing 15.0 to 19.0 mol % of the Li₂O component.

Then, in this first embodiment, their compositional ratio satisfies a compositional ratio represented by the compositional formula of Li₁₊ₓAlₓGe_{2-x-z}M_{z}P₃O₁₂ (x=0.2 to 0.6, z=0 to 0.1, and M is one or more selected from the group consisting of Zr, Ti, Sn, and Si). In other words, the first embodiment is a glass material in which the compositional ratio of P, Al, Ge, and Li is such a compositional ratio that it is of LAGP type (LAGP glass material). Note that the lower limit of x in the above compositional formula is preferably 0.25 or more, and more preferably 0.3 or more, and the upper limit thereof is preferably 0.55 or less, and more preferably 0.5 or less. Also, the lower limit of z in the above compositional formula may be more than 0 or may be 0.005 or more, and furthermore, the upper limit thereof is preferably 0.05 or less, and more preferably 0.03 or less. Then, M in the above compositional formula is more preferably one or more selected from the group consisting of Zr, Ti, and Sn, further preferably Zr and/or Sn, and still more preferably Zr.

(2) Essential Components and their Composition in Second Embodiment

The P₂O₅ component is, similarly, an essential component necessary for glass formation of the LAGP glass material of the second embodiment and for a lithium-ion conductive glass ceramic formed by sintering the second embodiment to include a crystal phase with a rhombohedral NASICON structure and to have an excellent lithium ion conductivity. Thus, the lower limit of the content of the P₂O₅ component is preferably 33.0 mol %, more preferably 34.0 mols, further preferably 35.0 mol %, still more preferably 36.0 mol %, and still further preferably 37.0 mol %. Also, since it can be made easier to obtain a crystal phase with a rhombohedral NASICON structure by sintering, the upper limit of the content of the P₂O₅ component is preferably 42.0 mol %, more preferably 41.0 mols, further preferably 40.0 mol %, still more preferably 39.0 mol %, and still further preferably 38.0 mol %. For example, the second embodiment is more suitable if it has a configuration containing 36.0 to 39.0 mol % of the P₂O₅ component.

The Al₂O₃ component is, similarly, an essential component necessary for a lithium-ion conductive glass ceramic formed by sintering the second embodiment to include a crystal phase with a rhombohedral NASICON structure and also to have an excellent lithium ion conductivity. Thus, the lower limit of the content of the Al₂O₃ component is preferably 0.5 mol %, more preferably 1.0 mol %, further preferably 2.0 mol %, still more preferably 3.0 mol %, and still further preferably 3.5 mol %. Also, since it can be made easier to obtain a crystal phase with a rhombohedral NASICON structure by sintering, the upper limit of the content of the Al₂O₃ component is preferably 10.0 mols, more preferably 9.0 mol %, further preferably 8.0 mol %, still more preferably 7.0 mol %, and still further preferably 6.5 mol %. For example, the second embodiment is more suitable if it has a configuration containing 2.0 to 7.0 mol % of the Al₂O₃ component.

The GeO₂ component is, similarly, also an essential component necessary for a lithium-ion conductive glass ceramic formed by sintering the second embodiment to include a crystal phase with a rhombohedral NASICON structure and also to have an excellent lithium ion conductivity. Thus, the lower limit of the content of the GeO₂ component is preferably 29.0 mol %, more preferably 30.0 mol %, further preferably 31.0 mol %, still more preferably 32.0 mol %, still further preferably 33.0 mol %, yet more preferably 34.0 mol %, yet further preferably 35.0 mol %, and even more preferably 36.0 mol %. Also, since it can be made easier to obtain a crystal phase with a rhombohedral NASICON structure by sintering, the upper limit of the content of the GeO₂ component is preferably 47.0 mol %, more preferably 46.0 mol %, further preferably 45.0 mol %, still more preferably 44.0 mol %, still further preferably 43.0 mol %, and yet more preferably 42.0 mol %. For example, the second embodiment is more suitable if it has a configuration containing 32.0 to 44.0 mol % of the GeO₂ component.

The Li₂O component is, similarly, an essential component necessary for imparting lithium ion conductivity to a lithium-ion conductive glass ceramic formed by sintering the second embodiment. Thus, the lower limit of the content of the Li₂O component is preferably 15.0 mol %, more preferably 16.0 mol %, and further preferably 17.0 mol %. Meanwhile, since it can be made easier to obtain a crystal phase with a rhombohedral NASICON structure by sintering, the upper limit of the content of the Li₂O component is preferably 25.0 mol %, more preferably 24.0 mol %, further preferably 23.0 mol %, still more preferably 22.0 mol %, still further preferably 21.0 mol %, and yet more preferably 20.0 mol %. For example, the second embodiment is more suitable if it has a configuration containing 18.0 to 23.0 mol % of the Li₂O component.

Then, in this second embodiment, their compositional ratio satisfies a compositional ratio represented by the compositional formula of Li₁₊ₓAlₓGe_{2-x-z}M_{z}P₃O₁₂+aLi₂O+bP₂O₅ (x=0.2 to 0.6, z=0 to 0.1, a=0.01 to 0.3, b=0 to 0.3, and M is one or more selected from the group consisting of Zr, Ti, Sn, and Si). In other words, the second embodiment is a glass material in which the compositional ratio of P, Al, Ge, and Li is such a compositional ratio that a predetermined amount of lithium oxide or lithium oxide and diphosphorus pentoxide, which can be a sintering auxiliary, is added to the LAGP type (LAGP glass material).

Note that the lower limit of x in the above compositional formula is preferably 0.25 or more, and more preferably 0.3 or more, and the upper limit thereof is preferably 0.55 or less, and more preferably 0.5 or less. Also, the lower limit of z in the above compositional formula may be more than 0 or may be 0.005 or more, and furthermore, the upper limit thereof is preferably 0.05 or less, and more preferably 0.03 or less. Then, M in the above compositional formula is more preferably one or more selected from the group consisting of Zr, Ti, and Sn, further preferably Zr and/or Sn, and still more preferably Zr. Furthermore, the lower limit of a in the above compositional formula is preferably 0.02 or more, more preferably 0.03 or more, and further preferably 0.04 or more, and the upper limit thereof is preferably 0.2 or less, more preferably 0.1 or less, and further preferably 0.07 or less. Moreover, the lower limit of b in the above compositional formula is preferably more than 0, more preferably 0.01 or more, and further preferably 0.02 or more, and the upper limit thereof is preferably 0.2 or less, more preferably 0.1 or less, and further preferably 0.05 or less.

### (3) Optional Component

Note that, although both the first embodiment and the second embodiment may have a configuration composed of the essential components described above, they may further include, as an optional component, one or more selected from the group consisting of the above-mentioned ZrO₂ component, TiO₂ component, SnO₂ component, and SiO₂ component, as well as a B₂O₃ component, a Nb₂O₅ component, a La₂O₃ component, an Y₂O₃ component, a Sc₂O₃ component, a CaO component, a MgO component, a Ta₂O₅ component, and oxides of transition metals such as Co, Ni, Mn, and Fe.

In particular, since it is easier to suppress the dissolution of moisture into the glass material during melting and to reduce the amount of moisture released at 550 to 700° C. when sintered and crystallized at a low temperature, it is more preferable that both the first embodiment and the second embodiment have a configuration further including the ZrO₂ component.

The ZrO₂ component is, as described above, an optional component that can reduce the amount of moisture released at 550 to 700° C. when the lithium-ion conductive glass ceramic precursor of the present invention is sintered and crystallized at a low temperature. It is also a component that can promote crystallization when the lithium-ion conductive glass ceramic precursor of the present invention is sintered. Furthermore, it is also a component that can contribute to improvement in the chemical durability of the lithium-ion conductive glass ceramic precursor of the present invention and a lithium-ion conductive glass ceramic formed by sintering the same. It is suitable that the content of the ZrO₂ component is preferably 0.05 mol % or more, more preferably 0.1 mol % or more, further preferably 0.15 mol % or more, and still more preferably 0.2 mol % or more. Meanwhile, it is suitable that the content is preferably 2.4 mol % or less, more preferably 2.0 mol % or less, further preferably 1.5 mol % or less, still more preferably 1.0 mol % or less, and still further preferably 0.5 mol % or less, since the melting temperature can be set lower when melting the raw materials and devitrification at the time of casting (glass lump formation) is more easily suppressed.

The SiO₂ component, B₂O₃ component, La₂O₃ component, and Nb₂O₅ component are all optional components that facilitate glass formation of the lithium-ion conductive glass ceramic precursor of the present invention. Also, the SiO₂ component can also increase the mechanical strength of a lithium-ion conductive glass ceramic formed by sintering the lithium-ion conductive glass ceramic precursor of the present invention. Note that it is suitable that the content of the SiO₂ component is preferably 5.0 mol % or less, more preferably 3.0 mol % or less, further preferably 2.0 mol % or less, and still more preferably 1.0 mol % or less. Then, it is suitable that the content of the B₂O₃ component is preferably 10.0 mol % or less, more preferably 8.0 mols or less, further preferably 5.0 mol % or less, and still more preferably 3.0 mol % or less. Furthermore, it is suitable that the content of the La₂O₃ component is preferably 10.0 mol % or less, more preferably 8.0 mol % or less, further preferably 5.0 mol % or less, still more preferably 3.0 mol % or less, and still further preferably 1.0 mol % or less. Moreover, it is suitable that the content of the Nb₂O₅ component is preferably 50.0 mol % or less, more preferably 40.0 mol % or less, further preferably 30.0 mol % or less, and still more preferably 20.0 mol % or less.

The SnO₂ component and the TiO₂ component are both optional components that can promote crystallization when the lithium-ion conductive glass ceramic precursor of the present invention is sintered. Note that it is suitable that the content of the TiO₂ component is preferably 5.0 mol % or less, more preferably 3.0 mol % or less, further preferably 2.0 mol % or less, and still more preferably 1.0 mol % or less. The lithium-ion conductive glass ceramic precursor of the present invention is characterized in that it can form a lithium-ion conductive glass ceramic with a high density even when its composition includes the GeO₂ component and is substantially free from the TiO₂ component (for example, less than 0.1 mol %). In addition, it is suitable that the content of the SnO₂ component is also preferably 5.0 mol % or less, more preferably 3.0 mol % or less, further preferably 2.0 mol % or less, and still more preferably 1.0 mol % or less.

The Sc₂O₃ component and the Y₂O₃ component are optional components that can substitute part of the Al₂O₃ component, and can adjust the lithium ion conductivity in a lithium-ion conductive glass ceramic formed by sintering the lithium-ion conductive glass ceramic precursor of the present invention. Note that it is suitable that the content of the Y₂O₃ component is preferably 10.0 mol % or less, more preferably 8.0 mol % or less, further preferably 5.0 mol % or less, still more preferably 3.0 mol % or less, and still further preferably 1.0 mol % or less. In addition, it is suitable that the content of the Sc₂O₃ component is also preferably 10.0 mol % or less, more preferably 5.0 mol % or less, and further preferably 3.0 mols or less.

The CaO component and the MgO component are optional components that can further increase the lithium ion conductivity of a lithium-ion conductive glass ceramic formed by sintering the lithium-ion conductive glass ceramic precursor of the present invention. Note that it is suitable that the content of the CaO component and the content of the MgO component are both preferably 10.0 mol % or less, more preferably 8.0 mol % or less, further preferably 5.0 mol % or less, and still more preferably 3.0 mol % or less.

The Ta₂O₅ component and transition metals such as Co, Ni, Mn, and Fe are optional components that can, when a lithium-ion conductive glass ceramic formed by sintering the lithium-ion conductive glass ceramic precursor of the present invention is used as a solid electrolyte and integrally molded with an electrode layer, suppress elution of a Ta₂O₅ component and transition metals included in the electrode active material (in particular, positive electrode active material) into the solid electrolyte. Note that it is suitable that the total content of the Ta₂O₅ component and oxides of these transition metals is preferably 20.0 mol % or less, more preferably 15.0 mol % or less, further preferably 10.0 mol % or less, and still more preferably 5.0 mol % or less.

Furthermore, the lithium-ion conductive glass ceramic precursor of the present invention may include, in addition to the above, a small amount (for example, 5.0 mol % or less, preferably 3.0 mol % or less, and more preferably 1.0 mol % or less) of a Na₂O component, a K₂O component, or oxides of other transition metals (such as Ag, Cu, and Au) since they are not likely to significantly affect its effectiveness. However, the configuration may be substantially free from one or more selected from these (for example, less than 0.1 mol %).

Note that, in the lithium-ion conductive glass ceramic precursor of the present invention, it is preferable to reduce the amount of sulfur(S) as much as possible (for example, less than 1 mol %, preferably less than 0.1 mol %), and it is more preferable that sulfur(S) is not included. This is because reduction of the amount of the S component can reduce the possibility of emission of toxic gas such as hydrogen sulfate in all-solid-state secondary batteries using a lithium-ion conductive glass ceramic formed by sintering the lithium-ion conductive glass ceramic precursor of the present invention as a solid electrolyte. It is also preferable to reduce the amount of zinc (Zn), arsenic (As), antimony (Sb), and lead (Pb) as much as possible, and it is more preferable that none of them are included. This is because they serve as toxic substances. Furthermore, from the viewpoint of expressing electronic conductivity, it is also preferable to reduce the amount of bismuth (Bi) and tellurium (Te) as much as possible, and it is more preferable that none of them are included. Moreover, from the viewpoint of maintaining the function of a solid electrolyte formed by sintering at a high level, it is also preferable to reduce the amount of vanadium (V) as much as possible, and it is more preferable that vanadium (V) is not included.

Then, the lithium-ion conductive glass ceramic precursor of the present invention, which has the components contained therein and the composition as described above, is a glass material (amorphous material). Therefore, the lithium-ion conductive glass ceramic precursor of the present invention before sintering is substantially free from crystal phases.

### <Amount of Moisture in Lithium-Ion Conductive Glass Ceramic Precursor>

In the lithium-ion conductive glass ceramic precursor of the present invention, the compositional ratio of P, Al, Ge, and Li satisfies a compositional ratio represented by the compositional formula described above, and the amount of moisture released in a predetermined temperature range when sintered and crystallized at a low temperature is at or below a certain amount.

Specifically, when particles of the lithium-ion conductive glass ceramic precursor of the present invention that have passed through a mesh with an aperture size of 106 μm (106 μm mesh-passed product) are sintered and crystallized (glass ceramization) at a temperature of 700° C. or lower, the amount of moisture (integrated value) released in a temperature range of 550 to 700° C. is 60 ppm or less per the lithium-ion conductive glass ceramic precursor. That is, gasification of moisture dissolved in the glass material during crystallization from the vitreous state by low temperature sintering is extremely small, in other words, gas generation and retention inside during formation of the crystal phase is extremely small, enabling formation of a lithium-ion conductive glass ceramic with a high density close to the theoretical value (for example, exceeding 90% of the theoretical value) in spite of being a LAGP glass material.

Here, “60 ppm or less per the lithium-ion conductive glass ceramic precursor” means that the amount of moisture released in a temperature range of 550 to 700° C. is 60 ppm (0.006 wt %) or less as a mass proportion with respect to the mass of the lithium-ion conductive glass ceramic precursor before sintering. Note that most of the moisture released in this temperature range is moisture dissolved in the glass material, while most of the moisture adsorbed (chemically adsorbed or physically adsorbed) on the surface of the glass material is released in a temperature range lower than this.

Note that this amount of moisture is preferably 55 ppm or less, more preferably 50 ppm or less, further preferably 48 ppm or less, still more preferably 45 ppm or less, still further preferably 42 ppm or less, yet more preferably 40 ppm or less, yet further preferably 38 ppm or less, even more preferably 36 ppm or less, even further preferably 34 ppm or less, even still more preferably 32 ppm or less, and even still further preferably 30 ppm or less.

Here, this amount of moisture is a value measured and calculated as follows. Specifically, when sintering and crystallizing particles of the lithium-ion conductive glass ceramic precursor of the present invention that have passed through a mesh with an aperture size of 106 μm (for example, that have passed through a mesh with an aperture size of 106 μm and that has an average particle diameter (D₅₀) of equal to or more than 30 μm and equal to or less than 100 μm, or even equal to or more than 40 μm and equal to or less than 100 μm) at a temperature of 700° C. or lower, by attaching a hygrometer (for example, HN-CJ manufactured by Chino Corporation, dew point meter TK-100 manufactured by Tekhne Co., Ltd., DM70 manufactured by Vaisala KK, or the like) to the later stage (for example, on the exit side) of a TG-DTA (for example, TG-DTA 200SA manufactured by Bruker or the like) and keeping records with a data recorder (for example, G400 manufactured by Graphtec Corporation), the amount of moisture released at 550 to 700° C. is calculated from the integrated value of the humidity of the hygrometer and the flow rate of the carrier gas (for example, nitrogen or the like). The flow rate of the carrier gas is set to, for example, 50 ml/min (0° C., in terms of 1 atm).

### <Form of Lithium-Ion Conductive Glass Ceramic Precursor>

The lithium-ion conductive glass ceramic precursor of the present invention is, as mentioned above, capable of forming a lithium-ion conductive glass ceramic with a higher density by sintering (crystallization) at 700° C. or lower, and its form is more preferably powder since it is easier to perform interface formation during integral sintering and other processes of an all-solid-state secondary battery and the precursor can be suitably used for co-sintering, where the positive electrode layer, solid electrolyte layer, negative electrode layer, and if necessary, interconnector layer are all integrally sintered and molded, and other processes. The interface formation here refers to both a triphasic interface that forms the three-dimensional structure of the electrode active material, conductive auxiliary, and solid electrolyte, and an interface among solid electrolyte materials themselves. This allows the lithium-ion conductive glass ceramic precursor in the form of powder to be softened by sintering to form an interface, which is then crystallized to provide a lithium-ion conductive glass ceramic with a high density, thus making it very suitable from the viewpoint of formation of a triphasic interface that forms the three-dimensional structure of the electrode active material, conductive auxiliary, and solid electrolyte of the all-solid-state secondary battery in co-sintering and other processes. In particular, from the viewpoints of forming an interface at a lower temperature, increasing the number of reaction interfaces, and reducing the thickness of the film of the electrolyte layer in the configuration of an all-solid-state secondary battery, it is preferable that the average particle diameter (D₅₀) of this powder is 2 μm or less (for example, equal to or more than 1 μm and equal to or less than 2 μm), or that the average particle size (D₅₀) of this powder is around 1 μm (for example, 2 μm or less, preferably 1.5 μm or less, and more preferably 1 μm or less).

Sheet forming or other methods may be used in the configuration of an all-solid-state secondary battery, but even as a constituent material for sheet forming, it is preferable to use the above-described lithium-ion conductive glass ceramic precursor of the present invention in the form of powder. At that time, in consideration of weather resistance and in order to suppress re-coagulation of particles, etc., it is suitable to use powder with a maximum particle size of 200 μm or less, more preferably 150 μm or less, and further preferably 120 μm or less, and with an average particle size (D₅₀) of 100 μm or less, more preferably about 80 μm or less, specifically, a 106 μm mesh-passed product or one obtained by pulverizing it such that the final maximum particle size is 1/20 or less of the target sheet film thickness, such as one with a maximum particle size of 1 μm or less if the target sheet film thickness is 20 μm. This makes it easier to suppress the reaction with the outside air until immediately before sheet forming. To make a 106 μm mesh-passed powder form from a glass lump, a stamp mill, a ball mill, a jaw crusher, or the like may be used, although there is no particular limitation.

In this regard, the “maximum particle size” and the “average particle size” refer to the maximum particle size and the average particle size in terms of volume (90% size in volume cumulative distribution (Deo) and 50% size in volume cumulative distribution (D₅₀)) measured by a laser diffraction/scattering particle size distribution measuring device.

Note that the lithium-ion conductive glass ceramic precursor of the present invention may be a mixture in which two or more glass materials are mixed (for example, powder mixed) or mixed and calcined (mixed and subjected to a heat treatment so that the vitreous state is maintained) so that the compositional ratio of P, Al, Ge, and Li satisfies a compositional ratio represented by any of the above-described compositional formulas. In other words, it may be a mixture in which two or more glass materials are mixed or mixed and calcined, and in which the compositional ratio of P, Al, Ge, and Li satisfies a compositional ratio represented by any of the above-described compositional formulas. Then, it is also suitable for this mixture to be powder that satisfies the maximum particle diameter, average particle diameter (D₉₀), or average particle diameter (D₅₀) as described above.

However, since the effect of the present invention is more easily demonstrated, it is more preferable for the lithium-ion conductive glass ceramic precursor of the present invention to be one vitrified glass material in which the compositional ratio of P, Al, Ge, and Li satisfies a compositional ratio represented by any of the above-described compositional formulas.

### <Method for Producing Lithium-Ion Conductive Glass Ceramic Precursor>

Next, the method for producing the lithium-ion conductive glass ceramic precursor of the present invention will be described in detail.

The lithium-ion conductive glass ceramic precursor of the present invention can be produced by a usual method for producing an amorphous inorganic material, such as calcination (preliminary calcination), melting, and vitrification of inorganic materials, as long as the method includes the melting conditions described later. There is no particular limitation on the inorganic materials used for production, but it is preferable to use lithium phosphate (Li₃PO₄), lithium metaphosphate (LiPO₃), germanium oxide (GeO₂), orthophosphoric acid (H₃PO₄), aluminum phosphate (Al(PO₃)₃), zirconium phosphate ((ZrO)₂(HPO₄)₂), or the like, and in particular, it is suitable to use lithium phosphate, lithium metaphosphate, germanium oxide, aluminum phosphate, and orthophosphoric acid as production raw materials.

Then, as for the melting conditions of the inorganic materials, it is necessary to perform melting in a nitrogen atmosphere (nitrogen atmosphere melting) in order to obtain a lithium-ion conductive glass ceramic precursor (LAGP glass material) in which the amount of moisture mentioned above is at or below a certain level. This can highly suppress dissolution of moisture into the glass material obtained by melting, thereby sufficiently reducing the amount of moisture mentioned above. If this nitrogen atmosphere melting is not performed, the amount of moisture mentioned above cannot be sufficiently reduced even when a nitrogen atmosphere is used in other glass material production processes or during crystallization (during sintering). Similarly, even when a dry air atmosphere with reduced humidity down to a dew point of about −10° C. is used instead of a nitrogen atmosphere in this melting, the amount of moisture mentioned above cannot be sufficiently reduced as well. In the case where calcination (preliminary calcination) is performed before melting, it is preferable to perform this calcination in a nitrogen atmosphere as well. Also, in the case where glass lumps are pulverized after melting, it is preferable to do so in a nitrogen atmosphere as well. The melting temperature is not limited, and is preferably 1000° C. or higher, more preferably equal to or higher than 1200° C. and equal to or lower than 1450° C.

### <Lithium-Ion Conductive Glass Ceramic>

Next, a lithium-ion conductive glass ceramic formed by sintering the lithium-ion conductive glass ceramic precursor of the present invention will be described in detail.

This lithium-ion conductive glass ceramic is a lithium-ion conductive glass ceramic including a crystal phase with a rhombohedral NASICON structure and a phase in the vitreous state (amorphous phase), obtained by sintering the lithium-ion conductive glass ceramic precursor of the present invention. Therefore, the constituent components and composition are substantially the same as the lithium-ion conductive glass ceramic precursor of the present invention before sintering unless a sintering auxiliary and the like are used. Then, it can be suitably used as a solid electrolyte for all-solid-state secondary batteries. In addition, since it can be formed by sintering at a sintering temperature as low as 700° C. or lower, decomposition of the electrode active material (positive electrode active material or negative electrode active material) and reduction in the discharge capacity (battery capacity) are difficult to occur even when integrally molded with the electrode layer, and also since it has a high density, its interface formation is also good, making it easy to form a dense film and the like.

In this regard, the “glass ceramics” used in the present invention means a material prepared by depositing crystal phase by heat treating a raw material, a glass material (amorphous material) or a material prepared by synthesizing crystal phase by heat treating a glass material and other materials. The glass ceramics includes both a crystal phase formed by heat treatment and an amorphous phase (non-crystal phase). In short, the “glass ceramics” is a mixture of ceramics and glass.

This lithium-ion conductive glass ceramic can be obtained by low temperature sintering from the lithium-ion conductive glass ceramic precursor of the present invention, as described above. Specifically, it can be obtained by using the lithium-ion conductive glass ceramic precursor of the present invention and sintering and crystallizing it by a sintering temperature of 700° C. or lower (for example, equal to or higher than 550° C. and equal to or lower than 680° C., or even equal to or higher than 550° C. and equal to or lower than 660° C.). Note that the lithium-ion conductive glass ceramic precursor of the present invention can form a lithium-ion conductive glass ceramic with a high density by low temperature sintering as it is, without separately adding and mixing a sintering auxiliary (a component that reduces the grain boundary resistance after crystallization).

Furthermore, although this lithium-ion conductive glass ceramic includes a crystal phase with a rhombohedral NASICON structure, which is also described above, it may also partially include lithium-ion conductive crystal phases with other structures (such as LISICON type, perovskite type, and garnet type). Even in this case, in all crystal phases included in this lithium-ion conductive glass ceramic (total crystal phases), the crystal phase with a rhombohedral NASICON structure accounts for more preferably 80% by mass or more, further preferably 90% by mass or more, still more preferably 95% by mass or more, and still further preferably 99% by mass or more. In short, it is preferable that the crystal phase with a rhombohedral NASICON structure constitutes the main crystal phase. It may also have a configuration in which the crystal phases included in this lithium-ion conductive glass ceramic are substantially composed of the crystal phase with a rhombohedral NASICON structure.

This lithium-ion conductive glass ceramic has a high density (for example, 2.85 g/cm³ or more) and a high lithium ion conductivity, and its density is preferably 2.86 g/cm³ or more, more preferably 2.87 g/cm³ or more, further preferably 2.88 g/cm³ or more, still more preferably 2.89 g/cm³ or more, still further preferably 2.90 g/cm³ or more, and yet more preferably 2.91 g/cm³ or more. Then, its lithium ion conductivity at 25° C. is preferably 4.0×10⁻⁵ S/cm or more, more preferably 9.0×10⁻⁵ S/cm or more, further preferably 1.0×10⁻⁴ S/cm or more, still more preferably 1.1×10⁻⁴ S/cm or more, still further preferably 1.2×10⁻⁴ S/cm or more, and yet more preferably 1.3×10⁻⁴ S/cm or more.

As described above, the lithium-ion conductive glass ceramic precursor of the present invention can form a LAGP lithium-ion conductive glass ceramic with a higher density by low temperature sintering at 700° C. or lower. This lithium-ion conductive glass ceramic has a high density and a high lithium ion conductivity, and thus can be suitably used as a solid electrolyte (such as solid electrolyte layer) in all-solid-state secondary batteries. That is, there can be formed an all-solid-state secondary battery including as a solid electrolyte a lithium-ion conductive glass ceramic formed by sintering the lithium-ion conductive glass ceramic precursor of the present invention. Note that, although it was difficult to form the LAGP lithium-ion conductive glass ceramic with a high density as mentioned above by low temperature sintering using conventional LAGP glass materials, the lithium-ion conductive glass ceramic precursor of the present invention can form the lithium-ion conductive glass ceramic with a high density as mentioned above, and thus can be suitably used as a production raw material for producing all-solid-state secondary batteries with good interface formation by co-sintering or other processes.

In the case where a layer that serves as an electrode layer of an all-solid-state secondary battery (positive electrode layer and/or negative electrode layer), an interconnector layer, and others are integrally molded, a known one may be used as this electrode layer. For example, an electrode layer for all-solid-state secondary batteries prepared by mixing an electrode active material (positive electrode active material or negative electrode active material) with a conductive auxiliary, an inorganic binder and the like, if necessary, and then sintering may be used. It is also possible to obtain an electrode layer (electrode layer including solid electrolyte) for an all-solid-state secondary battery by mixing and sintering the lithium-ion conductive glass ceramic precursor of the present invention with a positive electrode active material or a negative electrode active material at low temperature.

Examples of positive electrode active materials include NASICON type LiV₂(PO₄)₃, olivine type LiₓJ_{y}MtPO₄ (in which J is at least one or more selected from Al, Mg, or W, Mt is one or more selected from Ni, Co, Fe, or Mn, x satisfies 0.9≤x≤1.5 and y satisfies 0≤y≤0.2), layered oxide and spinel oxide. Examples of negative electrode active materials include oxide including a NASICON, an olivine, or a spinel crystal, rutile oxide, anatase oxide, amorphous metal oxide and metal alloy. Examples of conductive auxiliaries include a carbon compound such as plumbago, activated carbon and carbon nanotube, metal composed of at least one selected from Ni, Fe, Mn, Co, Mo, Cr, Ag, or Cu, an alloy thereof, metal such as titanium, stainless steel and aluminum, and precious metal such as platinum, gold, ruthenium and rhodium.

The embodiments described above are only an example for facilitating understanding of the present invention and do not limit the present invention. More specifically, the components illustrated above may be modified or improved without departing from the gist of the present invention, and the present invention of course includes the equivalent.

Hereinafter Examples of the present invention will be described, but the present invention is not limited to the following Examples, and may be modified in various ways within the technical scope of the present invention.

### EXAMPLES

Synthesis of lithium-ion conductive glass ceramic precursors of various compositions, which are glass materials, as well as a sintering test simulating all-solid-state secondary battery interface formation (low temperature sintering test) for them, were carried out.

### <Synthesis of Lithium-Ion Conductive Glass Ceramic Precursor>

The lithium-ion conductive glass ceramic precursor was synthesized by preliminary baking and melting in either an ambient atmosphere or a nitrogen atmosphere.

### (1) Glass Melting

Lithium metaphosphate (LiPO₃), lithium phosphate (Li₃PO₄), germanium oxide (GeO₂), orthophosphoric acid (H₃PO₄), aluminum phosphate (Al(PO₃)₃), and if necessary, zirconium phosphate ((ZrO)₂(HPO₄)₂) were used as raw materials.

Then, the raw materials were compounded so as to reach the stoichiometric ratio shown in Table 1 below, stirred at 1000 rpm for 5 minutes using Thinky Mixer (Awatori Rentaro), and then the amount of one batch was set to 200 g using a dispensing spoon. The mixed raw materials were placed in a platinum pot and heated to 1000° C. over 5 hours in either an ambient atmosphere or a nitrogen atmosphere as shown in the treatment condition in Table 1 below, then held for 1 hour and furnace-cooled to form preliminarily baked powder. This preliminarily baked powder was melted and vitrified with thoroughly stirring at 1200° C. or higher in a melting furnace with either an ambient atmosphere or a nitrogen atmosphere as shown in the treatment condition in Table 1 below (ambient atmosphere melting or nitrogen atmosphere melting), and cast on a metal cast plate to give various types of lithium-ion conductive glass ceramic precursors (glass lumps) of Comparative Examples 1 to 5 and Examples 1 to 10, which were glass materials. The obtained glass lumps varied in size such as 5 cm×10 cm to 2×3 cm. These glass lumps (about 3 to 10 cm) of the lithium-ion conductive glass ceramic precursors of Comparative Examples 1 to 5 and Examples 1 to 11 were pulverized using a stamp mill to a mesh pass of 106 μm or less. The pulverization atmosphere was a nitrogen atmosphere in all cases.

TABLE 1

| | Composition (mol %) | | | | | Treatment |
|---|---|---|---|---|---|---|
| | Li₂O | Al₂O₃ | GeO₂ | P₂O₅ | ZrO₂ | condition |
| Comp. | 17.50 | 5.00 | 40.00 | 37.50 | 0.00 | Ambient |
| Ex. 1 | | | | | | air |
| Comp. | 17.10 | 3.70 | 41.50 | 37.80 | 0.00 | Ambient |
| Ex. 2 | | | | | | air |
| Comp. | 17.50 | 5.00 | 39.63 | 37.50 | 0.38 | Ambient |
| Ex. 3 | | | | | | air |
| Comp. | 18.52 | 4.94 | 39.51 | 37.04 | 0.00 | Ambient |
| Ex. 4 | | | | | | air |
| Comp. | 18.52 | 4.94 | 39.14 | 37.04 | 0.37 | Ambient |
| Ex. 5 | | | | | | air |
| Ex. 1 | 17.50 | 5.00 | 40.00 | 37.50 | 0.00 | Nitrogen |
| Ex. 2 | 18.52 | 4.94 | 39.51 | 37.04 | 0.00 | Nitrogen |
| Ex. 3 | 18.52 | 4.94 | 39.14 | 37.04 | 0.37 | Nitrogen |
| Ex. 4 | 18.52 | 4.94 | 39.38 | 37.04 | 0.12 | Nitrogen |
| Ex. 5 | 18.52 | 4.94 | 39.01 | 37.04 | 0.49 | Nitrogen |
| Ex. 6 | 18.52 | 4.94 | 39.26 | 37.04 | 0.25 | Nitrogen |
| Ex. 7 | 18.40 | 4.91 | 38.90 | 37.42 | 0.37 | Nitrogen |
| Ex. 8 | 17.50 | 5.00 | 39.63 | 37.50 | 0.38 | Nitrogen |
| Ex. 9 | 19.75 | 6.17 | 36.67 | 37.03 | 0.37 | Nitrogen |
| Ex. 10 | 17.28 | 3.70 | 41.60 | 37.04 | 0.37 | Nitrogen |

<Sintering Test Simulating all-Solid-State Secondary Battery Interface Formation for Lithium-Ion Conductive Glass Ceramic Precursor>

For the above-described performance comparison, evaluation simulating interface formation during sintering of an all-solid-state secondary battery was performed. That is, the powder obtained by pulverizing the various types of lithium-ion conductive glass ceramic precursors synthesized as described above was molded and then sintered to fabricate solid electrolytes (lithium-ion conductive glass ceramics), and their density and lithium ion conductivity were evaluated. More specifically, the sintering test was performed by the following procedure.

In a 500 cc zirconia pot, the above-described pulverized lithium-ion conductive glass ceramic precursor (106 μm mesh-passed powder) and 1-propanol were added, and pulverization was performed in a planetary ball mill under conditions of 250 rpm and 2 hours (pulverized for 5 minutes, suspended for 1 minute) using φ 2 mm zirconia beads (YTZ beads manufactured by Nikkato Corporation) as the pulverization media. The slurry was separated from the zirconia beads after pulverization with a sieve, and then the resulting slurry was dried by using a shelf dryer with solvent recovery system (manufactured by The Institute of Creative Chemistry Co., Ltd.). The average particle diameters (D₉₀) of these obtained powders were all 2 μm or less (1 to 2 μm), and the average particle diameters (D₅₀) were all 1 μm or less.

The various types of dried powders obtained as described above were disintegrated using an alumina pestle and an alumina mortar to pass a 500 μm mesh, and then 1.5 g of the resultant was collected and molded using a φ 20 mm mold by applying a pressure of 20 kN to give various types of pellets for measuring lithium ion conductivity. Then, these various types of pellets for measuring lithium ion conductivity were sintered under a nitrogen atmosphere. After holding at 550° C., the temperature increase rate to 650° C. was slowed to 50° C./h, and a heat treatment was performed at 650° C. for 1 hour to give sintered pellets, which were solid electrolytes of glass ceramics (sintered pellets of Examples 1 to 10 and Comparative Examples 1 to 5).

The surface of the obtained sintered pellets was polished and dried using #800 and #2000 water proof abrasive paper and 1-propanol, and then the diameter, thickness and weight were measured using a vernier caliper, a micrometer and an electronic balance, respectively, to calculate the density.

As for the lithium ion conductivity measurement of the sintered pellets, a gold electrode was formed on both sides of the sintered body used for density measurement as a blocking electrode using a magnetron sputtering device (SC-701HMC manufactured by Sanyu Electron Co., Ltd.); and the impedance was measured using Electrochemical Measurement System (SP300 manufactured by Biologic) at 25° C. under conditions of a frequency of 0.1 Hz to 7 MHz, an amplitude voltage of 10 mV and an open circuit voltage to calculate the lithium ion conductivity.

Secondary electron image observation of the sintered pellets was performed with a scanning electron microscope (manufactured by JEOL Ltd., JSM-IT700HR/LA) to observe a broken-out section. The accelerating voltage was set to 5 kV and the distance to the sample (W. D.) was set to 10 mm.

In addition, aside from the above, measurement of the amount of moisture released when sintering and crystallizing the lithium-ion conductive glass ceramic precursor was performed by attaching a hygrometer (manufactured by Chino Corporation, HN-CJ) on the exit side (later stage) of a TG-DTA (manufactured by Bruker, TG-DTA 200SA) and keeping records with a data recorder (manufactured by Graphtec Corporation, G400). In addition, this TG-DTA (manufactured by Bruker, TG-DTA 200SA) was also used to measure the crystallization initiation temperature (Tc). The sample used was the above-described lithium-ion conductive glass ceramic precursor that had been pulverized to a mesh pass of 106 μm (particle size of 106 μm or less, average particle diameter (D₅₀) of about 50 to 80 μm). Since moisture generation is accompanied by diffusion in the material, in order to confirm the effect of particle size, for Comparative Example 4, measurement and evaluation were also performed on a 25 μm mesh-passed product (particle size of 25 μm or less) obtained by pulverizing the material in a ball mill. The measurement temperature was set to the range including 550 to 700° C., the carrier gas was set to nitrogen, and the carrier gas flow rate was set to 50 ml/min (0° C., in terms of 1 atm). From the integrated value of the humidity of the hygrometer and the carrier gas flow rate, the amount of moisture generated during crystallization (amount of moisture released at 550 to 700° C.) was calculated.

### <Evaluation Results>

The obtained results will be shown below for each of the evaluation items.

### (1) Evaluation of Amount of Moisture Released During Crystallization

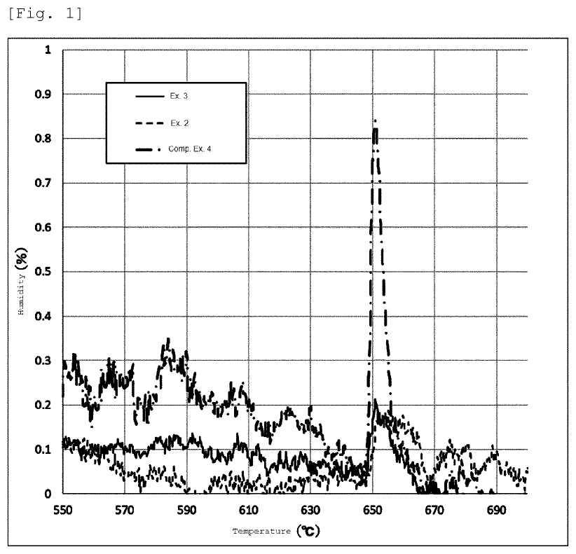

Table 2 below shows the melting treatment condition for the synthesized sample (treatment condition), the composition, the amount of moisture released at 550 to 700° C. during sintering (moisture), the density of the obtained sintered pellets, and the lithium ion conductivity (ion conductivity). In addition, as representative values, the humidity measurement results are shown in FIG. 1 for Comparative Example 4 with ambient atmosphere melting and Example 2 with nitrogen atmosphere melting, in which a=0.05, b=0, and x=0.4 were fixed, as well as for Example 3 with 0.015 of the replacing zirconia component (the density of the obtained sintered pellets was the highest). Note that FIG. 1 shows the humidity measurement results at 550 to 700° C. The amount of moisture detected (released) during crystallization (550 to 700° C.) was calculated to be 101.2 ppm for Comparative Example 4, 54.2 ppm for Example 2, and 24.5 ppm for Example 3 (Table 2), confirming that one with ambient atmosphere melting was the highest, nitrogen atmosphere melting reduced it to about half, and the addition of the zirconia component further reduced it to half. Also, the density of the sintered pellets was 2.75 g/cm³ for Comparative Example 4, which was the lowest, 2.86 g/cm³ for Example 2, and even 2.97 g/cm³ for Example 3, the value of which was 96% of the theoretical value (3.1 g/cm³). Although the lithium ion conductivity was 1×10⁻⁴ S/cm or more for all cases and there was no significant difference, they all had high values.

Furthermore, from the comparison between Comparative Example 1 and Example 1, where none of the lithium component, phosphorus component, or zirconia component was added to the basic composition of LAGP, the comparison between Comparative Example 4 and Example 2, where the lithium component was added, the comparison between Comparative Example 3 and Example 8, where only the zirconia component was added, the comparison between Comparative Example 5 and Examples 3 to 6, where the zirconia component was added in the composition with the lithium component added, and the results of Example 7, where the phosphorus component was further added thereto, and Example 9 and Example 10, where the composition of the aluminum component was changed in the composition with the lithium component added, in all cases, it was shown that the sintered pellets formed from glass materials obtained by ambient atmosphere melting where the amount of moisture released during crystallization was large tended to have low densities (Comparative Examples), while the density of the sintered pellets tended to be increased as the amount of moisture released during crystallization was reduced (Examples). In addition to nitrogen atmosphere melting, the replacement of the germanium component with the zirconia component was effective especially in increasing the density, but Comparative Example 3 and Example 8, where the lithium-ion component was not added, had slightly reduced lithium-ion conductivities of about 4×10⁻⁵ S/cm.

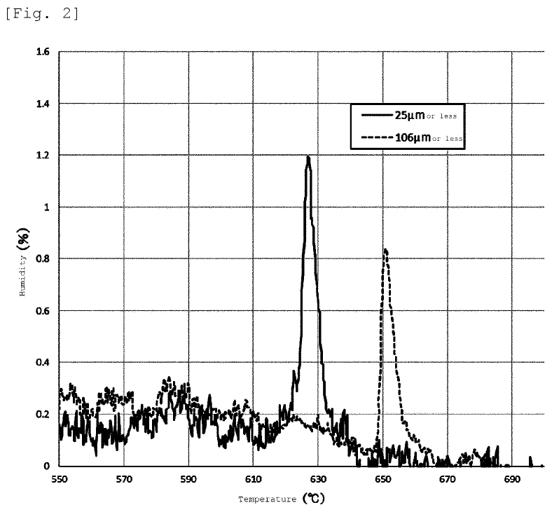

The particle size of the glass material (lithium-ion conductive glass ceramic precursor) for which the above-described amount of moisture was measured was a mesh pass of 106 μm, and there was concern about the effect of particle size on the moisture in the material due to the diffusion involved. Therefore, for the sample of Comparative Example 4, the amount of moisture was also checked in the 25 μm mesh-passed product. The humidity measurement results comparing them are shown in FIG. 2. Note that FIG. 2 also shows the humidity measurement results at 550 to 700° C. As a result, the amount of moisture released during crystallization (550 to 700° C.) was calculated to be 137 ppm even though the particle size was reduced to about one-fourth, and its variation remained to be 30% or less of that of the 106 μm mesh-passed product. From this, it was recognized that there was no significant effect of the difference in particle size in this measurement method. As for the temperature at which release of moisture is initiated during crystallization, the 25 μm mesh-passed product shifted slightly toward the lower temperature side (FIG. 2). This is presumed to be caused by promoted crystallization due to the smaller particle size. In the measurement results of the crystallization initiation temperature by the TG-DTA as well, the Tc of the 106 μm mesh-passed product was 645° C. and the Tc of the 25 μm mesh-passed product was 620° C., showing good agreement with the temperature at which release of moisture is initiated in the temperature range of 550 to 700° C. as shown in FIG. 2.

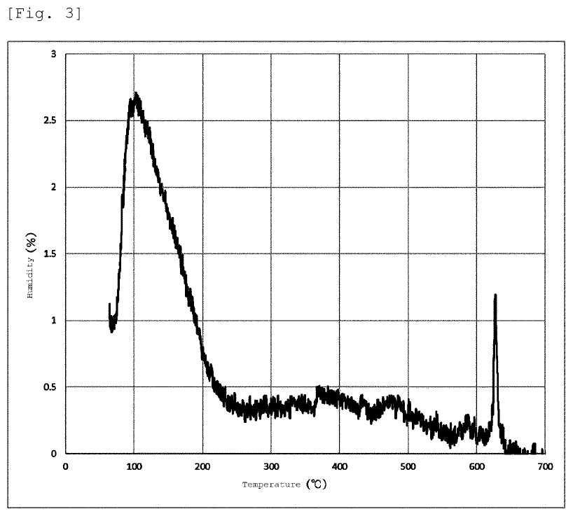

In addition, the humidity measurement results of this 25 μm mesh-passed product from the lower temperature are shown in FIG. 3. Here, an increase in humidity with a peak at 100° C. was observed. This is presumed to be adsorbed moisture adsorbed (chemically adsorbed or physically adsorbed) on the surface of the glass material, rather than moisture dissolved therein. The amount of moisture released here (the amount of moisture released at 60 to 150° C.) was calculated to be 0.45 wt % (4500 ppm), which was confirmed to be several tens of times larger than the amount of moisture released during crystallization. On the other hand, an increase in humidity with a peak around 620° C. was presumed to be due to the release of moisture dissolved in the glass material that could not be retained in the crystals during crystallization.

TABLE 2

| | | Composition | | | | Results | | |
|---|---|---|---|---|---|---|---|---|
| | | Li₁₊ₓAlₓGe_{2-x-z}Zr_{z}P₃O₁₂ + | | | | | | Ion |
| | Treatment | aLi₂O + bP₂O₅ | | | | Moisture | Density | conductivity |
| | condition | x | a | b | z | ppm | g/cm³ | S/cm |
| Comp. | Ambient | 0.400 | 0.000 | 0.000 | 0.000 | 143.4 | 2.64 | 8.30 × 10⁻⁵ |
| Ex. 1 | air | | | | | | | |
| Comp. | Ambient | 0.400 | 0.050 | 0.050 | 0.000 | 109.6 | 2.74 | 1.00 × 10⁻⁴ |
| Ex. 2 | air | | | | | | | |
| Comp. | Ambient | 0.400 | 0.000 | 0.000 | 0.015 | 74.2 | 2.81 | 4.50 × 10⁻⁵ |
| Ex. 3 | air | | | | | | | |
| Comp. | Ambient | 0.400 | 0.050 | 0.000 | 0.000 | 101.2 | 2.75 | 1.50 × 10⁻⁴ |
| Ex. 4 | air | | | | | | | |
| Comp. | Ambient | 0.400 | 0.050 | 0.000 | 0.015 | 72.1 | 2.83 | 1.60 × 10⁻⁴ |
| Ex. 5 | air | | | | | | | |
| Ex. 1 | Nitrogen | 0.400 | 0.000 | 0.000 | 0.000 | 57.7 | 2.85 | 9.20 × 10⁻⁵ |
| Ex. 2 | Nitrogen | 0.400 | 0.050 | 0.000 | 0.000 | 54.2 | 2.86 | 1.20 × 10⁻⁴ |
| Ex. 3 | Nitrogen | 0.400 | 0.050 | 0.000 | 0.015 | 24.5 | 2.97 | 1.40 × 10⁻⁴ |
| Ex. 4 | Nitrogen | 0.400 | 0.050 | 0.000 | 0.005 | 28.1 | 2.96 | 1.78 × 10⁻⁴ |
| Ex. 5 | Nitrogen | 0.400 | 0.050 | 0.000 | 0.020 | 20.3 | 2.86 | 1.46 × 10⁻⁴ |
| Ex. 6 | Nitrogen | 0.400 | 0.050 | 0.000 | 0.010 | 26.1 | 2.93 | 1.78 × 10⁻⁴ |
| Ex. 7 | Nitrogen | 0.400 | 0.050 | 0.025 | 0.015 | 35.5 | 2.90 | 1.20 × 10⁻⁴ |
| Ex. 8 | Nitrogen | 0.400 | 0.000 | 0.000 | 0.015 | 25.5 | 2.87 | 4.20 × 10⁻⁵ |
| Ex. 9 | Nitrogen | 0.500 | 0.050 | 0.000 | 0.015 | 30.2 | 2.90 | 1.15 × 10⁻⁴ |
| Ex. 10 | Nitrogen | 0.300 | 0.050 | 0.000 | 0.015 | 35.1 | 2.86 | 1.35 × 10⁻⁴ |

### (2) Appearance Confirmation by Secondary Electron Image Observation

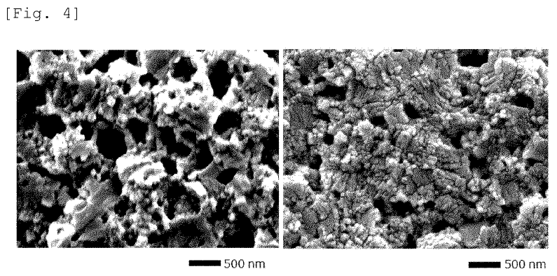

Since the density after low temperature sintering and the amount of moisture released during crystallization are considered to be in an inversely proportional relationship in LAGP glass materials, the cause of no increase in density after low temperature sintering can be attributed to gasification of dissolved moisture when the glass material is crystallized. In fact, as mentioned above, a higher density can be realized by suppressing the above-described amount of moisture released. Therefore, confirmation of gasification (release of moisture) and confirmation of its suppression were conducted by observation on appearance. For Comparative Example 1 and Example 3, which have the most significant difference, secondary electron image observation was performed on the broken-out section of the respective sintered pellets that had been sintered at a low temperature. The observation results are shown in FIG. 4. In Comparative Example 1, vacancies with an inner diameter of about 500 nm were scattered. The vacancies are thought to be generated by gasification of moisture dissolved inside the lithium-ion conductive glass ceramic precursor during crystallization. It is presumed that during crystallization, the precursor has undergone glass softening and thus has become densified and hermetically closed, resulting in fewer ways for the gas to escape, leading to such vacancies. On the other hand, in Example 3, although a few vacancies were observed, the number thereof was significantly smaller than that in Comparative Example 1, and an improvement was confirmed.

The present application claims priority to Japanese Patent Application No. 2022-181658 filed on Nov. 14, 2022, the entire disclosure of which is hereby incorporated.

1. A lithium-ion conductive glass ceramic precursor that is a glass material from which a lithium-ion conductive glass ceramic can be formed by sintering,
wherein a compositional ratio of P, Al, Ge, and Li satisfies a compositional ratio represented by a compositional formula of Li₁₊ₓAlₓGe_{2-x-z}M_{z}P₃O₁₂ (x=0.2 to 0.6, z=0 to 0.1, and M is one or more selected from the group consisting of Zr, Ti, Sn, and Si), and
when particles of the lithium-ion conductive glass ceramic precursor that have passed through a mesh with an aperture size of 106 μm are sintered and crystallized at a temperature of 700° C. or lower, an amount of moisture released at 550 to 700° C. is 60 ppm or less per the lithium-ion conductive glass ceramic precursor.

2. The lithium-ion conductive glass ceramic precursor according to claim 1, comprising, in mole percent on an oxide basis, 0.05 to 2.4% of a ZrO₂ component.

3. A lithium-ion conductive glass ceramic precursor that is a glass material from which a lithium-ion conductive glass ceramic can be formed by sintering,
wherein a compositional ratio of P, Al, Ge, and Li satisfies a compositional ratio represented by a compositional formula of Li₁₊ₓAlₓGe_{2-x-z}M_{z}P₃O₁₂+aLi₂O+bP₂O₅ (x=0.2 to 0.6, z=0 to 0.1, a=0.01 to 0.3, b=0 to 0.3, and M is one or more selected from the group consisting of Zr, Ti, Sn, and Si), and
when particles of the lithium-ion conductive glass ceramic precursor that have passed through a mesh with an aperture size of 106 μm are sintered and crystallized at a temperature of 700° C. or lower, an amount of moisture released at 550 to 700° C. is 60 ppm or less per the lithium-ion conductive glass ceramic precursor.

4. The lithium-ion conductive glass ceramic precursor according to claim 3, comprising, in mole percent on an oxide basis, 0.05 to 2.4% of a ZrO₂ component.

5. An all-solid-state secondary battery comprising as a solid electrolyte a lithium-ion conductive glass ceramic formed by sintering the lithium-ion conductive glass ceramic precursor according to claim 1.

6. An all-solid-state secondary battery comprising as a solid electrolyte a lithium-ion conductive glass ceramic formed by sintering the lithium-ion conductive glass ceramic precursor according to claim 2.

7. An all-solid-state secondary battery comprising as a solid electrolyte a lithium-ion conductive glass ceramic formed by sintering the lithium-ion conductive glass ceramic precursor according to claim 3.

8. An all-solid-state secondary battery comprising as a solid electrolyte a lithium-ion conductive glass ceramic formed by sintering the lithium-ion conductive glass ceramic precursor according to claim 4.
